(19) United States
(12) Patent Application Publication
(10) Pub. No.: US 2025/0370481 A1
(43) Pub. Date: Dec. 4, 2025

(54) SYSTEM AND METHOD FOR CONTROLLING PLURALITY OF MECHANICALLY CONNECTABLE MOBILITIES

(71) Applicants: Hyundai Motor Company, Seoul (KR); Kia Corporation, Seoul (KR)

(72) Inventors: Hyuntek Lim, Hwaseong-si (KR); Dong Hwan Kwak, Hwaseong-si (KR); Sanghyeon Oh, Hwaseong-si (KR)

(21) Appl. No.: 18/924,102

(22) Filed: Oct. 23, 2024

(30) Foreign Application Priority Data
Jun. 3, 2024 (KR) 10-2024-0072368

(51) Int. Cl. G05D 1/695; G05D 1/698; G05D 111/30

(52) U.S. Cl. CPC G05D 1/696; G05D 1/6987; G05D 2111/32

(57) ABSTRACT

In a system for controlling a number of mobilities, in which the mobilities include a driving mobility and a driven mobility that can be mechanically connectable to the driving mobility by a mechanical coupling. The driving mobility and the driven mobility may be communicatively connected to each other. The system may include a control server that is communicatively connected to the driving mobility and the driven mobility, and is configured to receive data confirming a state of the driving mobility and the driven mobility, determine whether a connection condition is satisfied based on the data, and transmit a connection command to the driving mobility and the driven mobility in response to the connection condition being satisfied. A method for controlling a number of mobilities using the system is further disclosed.

### CROSS-REFERENCE TO RELATED APPLICATIONS

This application claims priority to and the benefit of Korean Patent Application No. 10-2024-0072368 filed in the Korean Intellectual Property Office on June 3, 2024, the entire contents of which are incorporated herein by reference.

### TECHNICAL FIELD

The present disclosure relates to a system and a method for controlling a plurality of mechanically connectable mobilities.

### BACKGROUND

Recently, the use of eco-friendly mobility including electric vehicles is increasing. Because the eco-friendly mobility is driven using electric energy charged in a battery instead of being driven by burning fuel, a drivable range of the eco-friendly mobility is determined depending on the capacity of the battery. In other words, the larger the battery capacity, the greater the drivable range of the eco-friendly mobility. However, because a battery mounting space is limited in the eco-friendly mobility, the battery capacity is also limited.

When a plurality of mobilities perform cooperative work, a control server connected to all of the plurality of mobilities may control driving and/or operation of each mobility. In this case, because the corresponding control server should perform calculation for controlling the driving and/or the operation of all the mobilities connected to the control server, a control server with sufficient calculation capacity is required. In addition, even if some of the mobilities connected to the control server are to be controlled, the control server may have to calculate the driving and/or the operation of all the mobilities connected to the control server. Accordingly, the control server may perform a considerable amount of unnecessary calculation.

In contrast, each of the plurality of mobilities performing cooperative work may control its own driving and/or operation. In this case, each of the plurality of mobilities may require not only the calculation for controlling its own driving and/or operation, but also additional calculations for controlling the driving and/or operation of other mobilities performing the cooperative work. Accordingly, each mobility needs to have sufficiently large calculation capacity.

The above information disclosed in this Background section is for enhancement of understanding of the background of the present disclosure and it may contain information that does not form the prior art that is already publicly known, in use, or available.

### SUMMARY

The present disclosure relates to a system and a method for controlling a plurality of mechanically connectable mobilities, and more particularly, to a system and a method for controlling a plurality of mechanically connectable mobilities in which the plurality of mobilities may be mechanically connected and controlled integrally or each of the plurality of mobilities may be individually controlled.

An embodiment of the present disclosure can provide a system and a method for controlling a plurality of mechanically connectable mobilities in which the plurality of mobilities may be mechanically connected and controlled integrally or each of the plurality of mobilities may be individually controlled.

According to an example embodiment of the present disclosure, a system for controlling a plurality of mobilities is disclosed.

The plurality of mobilities may include a driving mobility and a driven mobility that is mechanically connectable to the driving mobility by a mechanical coupling, and the driving mobility and the driven mobility may be communicatively connected to each other.

The system may include a control server that is communicatively connected to the driving mobility and the driven mobility, and is configured to receive data confirming a state of the driving mobility and the driven mobility, determine whether a connection condition is satisfied based on the data, and transmit a connection command to the driving mobility and the driven mobility in response to the connection condition being satisfied.

The control server or the driving mobility may control the driving mobility and the driven mobility to be mechanically connected by a mechanical coupling in response to receiving a connection command, and the control server, the driving mobility, or the driven mobility may be configured to control the driving mobility and the driven mobility to perform an integrated mission in response to completion of the mechanical connection of the driving mobility and the driven mobility.

Performing the integrated mission performed by the driving mobility and the driven mobility may include selecting an operation mode, distributing a role to the driving mobility and the driven mobility according to the operation mode, and performing the distributed role by the driving mobility and the driven mobility.

The operation mode may include: a traction mode that operates only with a driving force of the driving mobility; a distributed mode in which the driving mobility and the driven mobility distribute and process a calculation and an operation for performing the integrated mission; and an expansion mode in which both the driving force of the driving mobility and a driving force of the driven mobility are used.

In the traction mode, the driving mobility may be configured to process the calculation for controlling the integrated mission and control an operation of the driving mobility according to the calculation.

In the distributed mode, the driving mobility and the driven mobility may be configured to process the calculation for controlling the integrated mission and control the operation of the driving mobility and the driven mobility according to the calculation.

In the expansion mode, a processor of the driving mobility may be configured to process the calculation for controlling the integrated mission and control the operation of the driving mobility and the driven mobility according to the calculation.

The control server, the driving mobility, or the driven mobility may control the driving mobility and the driven mobility to be separated from each other in response to the completion of the performance of the integrated mission.

The control server may be further configured to transmit the state of the driven mobility or the driving mobility to the driving mobility or the driven mobility.

The driving mobility or the driven mobility may include a user interface, and the state of the driving mobility or the driven mobility received from the control server may be displayed through the user interface.

The driving mobility or the driven mobility may be configured to receive a driver's input through the user interface and transmit the received driver's input to the control server.

According to an example embodiment of the present disclosure, a method for controlling a plurality of mobilities is disclosed. The plurality of mobilities may include a driving mobility and a driven mobility that is mechanically connectable to the driving mobility by a mechanical coupling, and the driving mobility and the driven mobility may be communicatively connected to each other, and communicatively connected to a control server.

The method may include: determining, by the control server, whether a connection condition is satisfied; controlling, by the control server or the driving mobility, a mechanical connection of the driving mobility and the driven mobility in response to the connection condition being satisfied; and controlling, by the control server or the driving mobility, the driving mobility and the driven mobility to perform an integrated mission in response to completion of the mechanical connection of the driving mobility and the driven mobility.

The controlling of the driving mobility and the driven mobility to perform the integrated mission may include: selecting an operation mode; distributing a role to the driving mobility and the driven mobility according to the operation mode; and performing the distributed role by the driving mobility and the driven mobility.

The operation mode may include: a traction mode that operates only with a driving force of the driving mobility; a distributed mode in which the driving mobility and the driven mobility distribute and process a calculation and an operation for performing the integrated mission; and an expansion mode in which both the driving force of the driving mobility and the driving force of the driven mobility are used.

In the traction mode, the driving mobility may be configured to process the calculation for controlling the integrated mission and control the operation of the driving mobility according to the calculation.

In the distributed mode, the driving mobility and the driven mobility may be configured to process the calculation for controlling the integrated mission and control the operation of the driving mobility and the driven mobility according to the calculation.

In the expansion mode, a processor of the driving mobility may be configured to process the calculation for controlling the integrated mission and control the operation of the driving mobility and the driven mobility according to the calculation.

The control method may further include: controlling the driving mobility and the driven mobility so that the driving mobility and the driven mobility are separated from each other in response to the completion of the performance of the integrated mission by the control server, the driving mobility, or the driven mobility.

According to an embodiment of the present disclosure, when the plurality of mobilities are mechanically connected, one of the plurality of mobilities can operate as the driving mobility and the remaining mobilities can operate as the driven mobilities, and the driving mobility and all the driven mobilities may be considered and controlled as one integrated mobility. Accordingly, because one of the plurality of mobilities performing the cooperative work performs the operation for controlling the integrated mobility, the unnecessary duplicate operations can be reduced or not performed.

When the driving mobility and all the driven mobilities operate independently, each mobility may receive the information from the other mobilities and perform the operation for its own control.

Other advantages that may be obtained or are predicted by example embodiments will be explicitly or implicitly described in a detailed description of example embodiments. That is, various advantages that are predicted according to example embodiments will be described in the following detailed description.

### BRIEF DESCRIPTION OF THE DRAWINGS

Example embodiments of the present disclosure may be better understood by referring to the following description in conjunction with the accompanying drawings, where like reference numerals can refer to identical or functionally similar elements.

FIG. 1 is a diagram schematically illustrating a system for controlling a plurality of mobilities according to an example embodiment of the present disclosure.

FIG. 2 is a diagram illustrating an example of a state in which one driving mobility and one driven mobility are mechanically connected, according to an example embodiment of the present disclosure.

FIG. 3 is a block diagram illustrating a configuration of a driving mobility or a driven mobility, according to an example embodiment of the present disclosure.

FIG. 4 is a flowchart of a method for controlling a plurality of mobilities according to an example embodiment of the present disclosure.

FIGS. 5A to 5D are diagrams illustrating various examples of a plurality of mobilities that are mechanically connected, according to example embodiments of the present disclosure.

It can be understood that the drawings referenced above are not necessarily drawn to scale, and can be rather simplified representations of various features illustrating principles of the present disclosure. For example, specific design features of an embodiment of the present disclosure, including specific dimensions, direction, position, and shape, can be determined in part by specific intended applications and use environments.

### DETAILED DESCRIPTION OF ILLUSTRATIVE EMBODIMENTS

The terminology used herein is for the purpose of describing particular example embodiments, and is not intended to necessarily limit the present disclosure. As used herein, singular forms can be intended to also include plural forms, unless the context clearly dictates otherwise. The terms "includes" and/or "including," specify the cited features, integers, steps, operations, elements, and/or the presence of components when used herein, but it can also be understood that these terms do not exclude the presence or addition of one or more of other features, integers, steps, operations, elements, components, and/or groups thereof. As used herein, the term “and/or” can include any one of or any combination of the associated listed items.

As used in this specification, a "mobility" or other similar terms can include a general land mobility including passenger vehicles, including sport utility vehicles (SUVs), a bus, a truck, various commercial vehicles, etc., a marine mobility including various types of boats and ships, and an aerial mobility including aircraft, a drone, etc., and can include all objects that may move by receiving power from a power source. In addition, as used in this specification, a “mobility” or other similar terms can be understood as including a hybrid mobility, an electric mobility, a plug-in hybrid mobility, a hydrogen-powered mobility, and other alternative fuel (e.g., fuels derived from resources other than oil) mobility. As described in this specification, the hybrid mobility can include a mobility with two or more power sources such as a gasoline powered and electric powered mobility. A mobility according to an example embodiment of the present disclosure can include a mobility driven somewhat autonomously and/or automatically as well as a mobility driven manually.

It can be understood that one or more of the methods below or embodiments thereof may be executed by at least one or more controllers. The term “controller” may refer to a hardware device including a memory and a processor, either or both of which may be in plural or may include plural components thereof. The memory can be configured to store program instructions, and the processor can be specifically programmed to execute the program instructions to perform one or more processes described in more detail below. The controller may control operations of units, modules, parts, devices, or the like, as described herein. It can be understood that methods below may be executed by an apparatus including a controller in conjunction with one or more other components, as can be appreciated by those skilled in the art.

The controller of an embodiment of the present disclosure may be implemented as a non-transitory computer-readable recording medium (storage medium) including executable program instructions executed by at least one processor. Examples of the computer-readable recording medium include ROM, RAM, compact disk (CD) ROM, magnetic tapes, floppy disks, flash drives, smart cards, and optical data storage devices, but are not limited thereto. The computer-readable recording medium may also be distributed throughout a computer network so that the program instructions may be stored and executed in a distributed manner, for example, on a telematics server or a controller area network (CAN).

Hereinafter, example embodiments of the present disclosure will be described in detail with reference to the accompanying drawings.

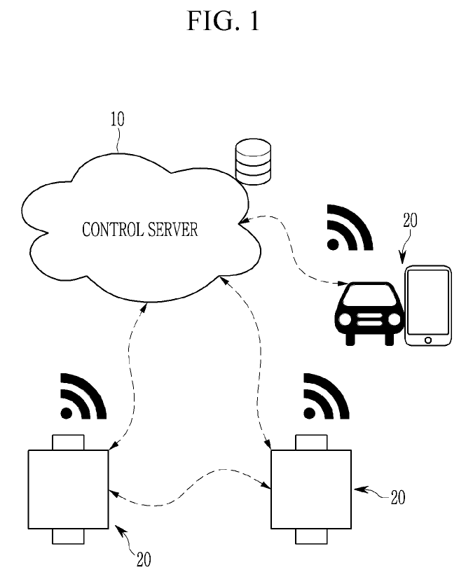

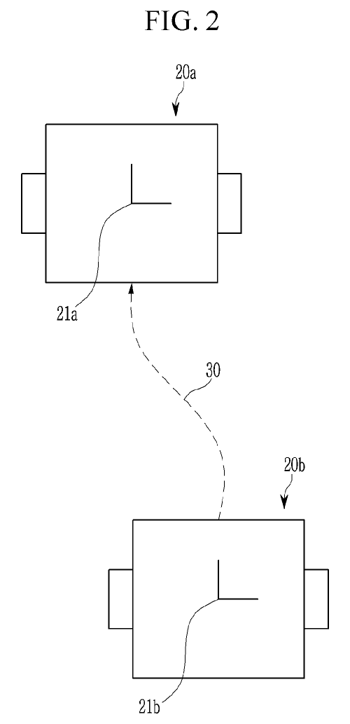

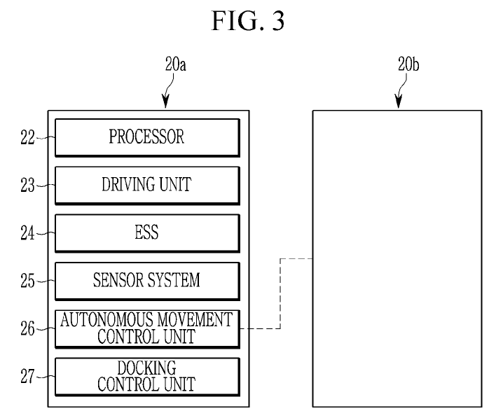

FIG. 1 is a diagram schematically illustrating a system for controlling a plurality of mobilities according to an example embodiment of the present disclosure. FIG. 2 is a diagram illustrating an example of a state in which one driving mobility and one driven mobility are mechanically connected. FIG. 3 is a block diagram illustrating a configuration of a driving mobility or a driven mobility.

As illustrated in FIG. 1, a system for controlling a plurality of mobilities according to an example embodiment of the present disclosure may include a control server 10 and a plurality of mobilities 20. The control server 10 and each mobility 20 may be communicatively connected to each other, and one mobility 20 may be communicatively connected to other mobilities 20. In one example, the control server 10 and the plurality of mobilities 20 may be communicatively connected to each other wirelessly (e.g., via Wi-Fi, etc.).

The control server 10 may be communicatively connected to each mobility 20, receive data that may confirm a state of each mobility 20, and transmit a control command for controlling each mobility 20 to the corresponding mobility 20 based on the data. The control server 10 may transmit the state of the other mobilities 20 to each mobility 20 to be used for controlling each mobility 20. For example, the state of the mobility 20 may include at least one of a position of the mobility 20, a state of charge (SOC) of a battery in the mobility 20, an operation mode, mission, and role of the mobility 20, whether the mobility 20 is driving autonomously, and a route on which the mobility 20 is moving. The control command may include at least one of a connection command for connecting one mobility 20 to the other mobilities 20, a separation command for separating one mobility 20 from the other mobilities 20, a charging command, a command for an operation mode, a mission, and/or a role (e.g., a command to perform a specific operation mode, a specific mission, and/or a role), and/or a command for a driving mode (e.g., a command to perform an autonomous driving mode or a driving control command).

Each mobility 20 may be communicatively connected to the control server 10 and/or the other mobilities 20. Some of the plurality of mobilities 20 may drive autonomously without a driver riding therein or may drive according to the driving control command of the control server 10, and others of the plurality of mobilities 20 may have a driver riding therein and may drive by a driver's operation, drive autonomously, drive according to the driving control command of the control server 10, or any combination thereof. The mobility 20 in which a driver can ride may include a user interface. The driver may input various commands for operating the mobility 20 through the user interface, and/or the control server 10 may transmit various information (e.g., information on the state of other mobilities 20, the route to be driven, the operation mode, the mission, and/or the role) to the mobility 20 so that the information may be displayed on the user interface.

As illustrated in FIG. 2, the plurality of mobilities 20 can include at least one driving mobility 20a and at least one driven mobility 20b. The driving mobility 20a can be a mobility 20 that controls the operation of the integrated mobility that is mechanically connected to the driven mobility 20b, and the driven mobility 20b can be a mobility 20 that operates under the control of the driving mobility 20a in an integrated state with the driving mobility 20a. For example, the driving mobility 20a may control the mechanical connection with the driven mobility 20b, and may distribute roles to the driving mobility 20a and the driven mobility 20b depending on the operation mode to control the integrated mobility to perform the integrated mission. The driven mobility 20b can control its own operation while it is not integrated with the driving mobility 20a, and may operate under the control of the driving mobility 20a while the integration with the driving mobility 20a is requested or while the driven mobility 20b is integrated with the driving mobility 20a.

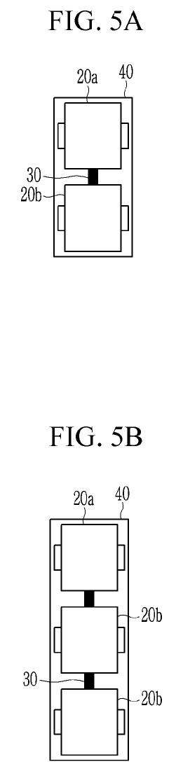

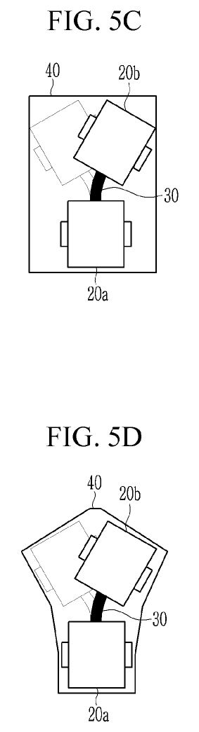

The driven mobility 20b may be mechanically connected to the driving mobility 20a or another driven mobility 20b via a mechanical coupling 30. The mechanical coupling 30 may be a hook, a joint, a chain, etc., for example. However, the type of the mechanical coupling 30 is not particularly limited, and the driving mobility 20a and the driven mobility 20b can be moved as a single rigid body (see FIGS. 5A and 5B), or the driven mobility 20b can swing relative to the driving mobility 20a (see FIGS. 5C and 5D). The specifications of the mechanical coupling 30 provided to the mobility 20 may be stored in a processor 22 of the mobility 20.

The processor 22 of the driving mobility 20a may store a reference 21a of the driving mobility 20a, an outer surface of the driving mobility 20a with respect to the reference 21a of the driving mobility 20a, and a relative position of the mechanical coupling 30, and the processor 22 of the driven mobility 20b may store a reference 21b of the driven mobility 20b, an outer surface of the driven mobility 20b with respect to the reference 21b of the driven mobility 20b, and a relative position of the mechanical coupling 30.

Hereinafter, the configuration of the driving mobility 20a or the driven mobility 20b will be described in more detail with reference to FIG. 3.

As illustrated in FIG. 3, the mobility 20 (the driven mobility 20a or the driven mobility 20b) may include the processor 22, a driving unit 23, an energy storage system (ESS) 24, a sensor system 25, an autonomous movement control unit 26, and a docking control unit 27, any combination of or all of which may be in plural or may include plural components thereof.

The processor 22 can be provided to the mobility 20 and control the overall operation of the mobility 20. For example, the processor 22 may communicate with the control server 10 or the processor 22 of other mobilities 20 and receive the control command from the control server 10. The processor 22 may receive the driver's input through the user interface. The processor 22 may control the driving unit 23, the energy storage system (ESS) 24, the sensor system 25, the autonomous movement control unit 26, the docking control unit 27, or the processor 22 of other mobilities 20, or any combination thereof, in response to receiving the control command from the control server 10 and/or the driver’s input through the user interface. The processor 22 may receive the state of the other mobilities 20 from the control server 10 and/or the processor 22 of the other mobilities 20. In response to receiving the state of the other mobilities 20, the processor 22 may display the state of the other mobilities 20 on the user interface and/or control the operation of the corresponding mobility 20 and/or the other mobilities 20 based on the state of the other mobilities 20 and/or the control command/driver’s input.

As described above, the control command/driver’s input may include at least one of the connection command/input for connecting one mobility 20 to the other mobilities 20, the separation command/input for separating one mobility 20 from the other mobilities 20, the charging command/input, the command/input for the operation mode, the mission, and/or the role, and the command/input for the driving mode. The connection command/input may include information on the other mobility 20 (e.g., identification information of the other mobilities 20, positions of the other mobilities 20, etc.), identification information of the mechanical coupling 30 to be used, etc., and the separation command/input may include information on the mobility 20 to be separated, etc. The charging command/input may include information on a position of a charging station or a route to the charging station, a state of charge to be charged, etc. The command/input for the operation mode, the mission, and/or the role may include information necessary to perform the operation mode, the mission, and/or the role, and the command/input for the driving mode may include information necessary to perform the driving mode.

The state of the mobility 20 may include at least one of the location of the mobility 20, the state of charge (SOC) of the battery in the mobility 20, the operation mode, the mission, and the role of the mobility 20, whether the mobility 20 is driving autonomously, and the route on which the mobility 20 is moving.

The driving unit 23 can be mounted on the mobility 20 and receive power from the energy storage system 24 to move the mobility 20. The driving unit 23 may include, but is not limited to, at least one wheel and at least one driving motor that is connected to the at least one wheel to rotate the at least one wheel. The driving unit 23 may further include a steering device that steers the mobility 20.

The energy storage system 24 can be mounted in the mobility 20 and may receive and store electric energy from a charging station or discharge the electric energy to drive the driving unit 23 under the control of the processor 22.

The sensor system 25 may detect information on the state of the mobility 20, for the autonomous movement, or for the mechanical connection with the other mobilities 20, and transmit the information to the processor 22. In response to receiving the information, the processor 22 may transmit the information to the control server 10 and/or the other mobilities 20, and/or control the autonomous movement or the mechanical connection with the other mobilities 20 based on the information. The information may include, but is not necessarily limited to, the position, speed, acceleration, posture, or the state of charge of the mobility 20, or any combination thereof.

The autonomous movement control unit 26 may control the driving unit 23 to move the mobility 20 to a target position (e.g., a charging station, other mobilities, or a mission execution position, etc.). The autonomous movement control unit 26 may plan a route from the current position to the target position, calculate a target speed and/or a target torque of the mobility 20 when driving along the route, and/or control the driving unit 23 so that the mobility 20 moves with the target speed and/or the target torque along the route.

The docking control unit 27 can be configured to control the mechanical connection of the mobility 20 and the other mobilities 20. For example, the docking control unit 27 may control the mobility 20 or the other mobilities 20 so that the mobility 20 and the other mobilities 20 requiring the mechanical connection move toward each other, and control the mechanical coupling 30 while the mobility 20 and the other mobilities 20 are close to each other to mechanically connect the mobility 20 and the other mobility 20.

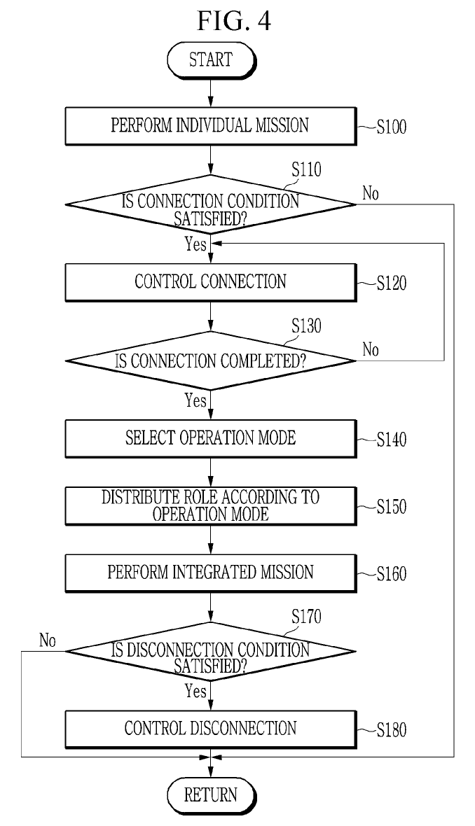

Hereinafter, a method for controlling a plurality of mobilities according to an example embodiment of the present disclosure will be described with reference to FIG. 4.

FIG. 4 is a flowchart of a method for controlling a plurality of mobilities according to an example embodiment of the present disclosure.

As illustrated in FIG. 4, a method for controlling a plurality of mobilities 20 according to an example embodiment of the present disclosure can start with each of the plurality of mobilities 20 performing an individual mission in operation S100. The individual mission can be a mission performed while each mobility 20 is not mechanically connected to the other mobilities 20, and generally can be a mission performed by the control server 10 and/or the processor 22 of the corresponding mobility 20. In contrast, the integrated mission can be a mission performed while the driving mobility 20a and the driven mobility 20b are mechanically connected, and the mission can be mainly performed by the control of the processor 22 of the driving mobility 20a, but if necessary, the control server 10 and/or the processor 22 of the driven mobility 20b may also control the performance of the integrated mission. For example, the mission may include, but is not limited to, charging, moving to a destination, transporting cargo, exploring a new area, etc.

While each mobility 20 is performing the individual mission, the control server 10 can determine whether the connection condition is met in operation S110. For example, when it is determined that the state of charge of any mobility 20 is insufficient to perform the individual mission without being connected to the other mobilities 20, it can be determined that the state of charge of any mobility 20 needs to be preserved, it can be determined that an area where the mission needs to be performed has expanded, and/or it can be determined that it is efficient for the plurality of mobilities 20 to be mechanically connected and operated (e.g., when the plurality of mobilities 20 positioned adjacent to each other need to move to the same destination), the control server 10 may determine that the connection condition is satisfied.

When it is determined that the connection condition is satisfied in the operation S110, the control server 10 can transmit the connection command to the mobility 20 that satisfies the connection condition and the mobility 20 to be connected to the corresponding mobility 20. The connection command may include designation of the driving mobility 20a and the driven mobility 20b.

The driving mobility 20a and the driven mobility 20b that receive the connection command can perform the mechanical connection process in operation S120. For example, under the control of the control server 10 and/or the processor 22 of the driving mobility 20a, the driving mobility 20a and the driven mobility 20b can move toward each other, and the mechanical coupling 30 can connect the driving mobility 20a and the driven mobility 20b to each other.

Thereafter, the processor 22 of the driving mobility 20a and/or the control server 10 can determine whether the mechanical connection between the driving mobility 20a and the driven mobility 20b is completed in operation S130.

When the mechanical connection between the driving mobility 20a and the driven mobility 20b is not completed in the operation S130, the method can proceed to the operation S120, and the processor 22 of the driving mobility 20a and/or the control server 10 can continue to perform the mechanical connection process.

When the mechanical connection of the driving mobility 20a and the driven mobility 20b is completed in the operation S130, the processor 22 of the driving mobility 20a and/or the control server 10 can select the operation mode in operation S140, and distribute the roles to the driving mobility 20a and the driven mobility 20b according to the operation mode in operation S150, and the driving mobility 20a and the driven mobility 20b can perform the roles distributed to the driving mobility 20a and the driven mobility 20b and perform the integrated mission in operation S160. The operation mode may be selected according to the satisfied connection conditions, and may include, but is not limited to, a traction mode, a distribution mode, and an expansion mode. The traction mode can be a mode that operates only with the driving force of the driving mobility 20a when the state of charge of the driven mobility 20b is insufficient or when it is necessary to preserve the state of charge of the driven mobility 20b. The distributed mode can be a mode in which the processor 22 of the driving mobility 20a and the processor 22 of the driven mobility 20b distribute and process calculations and operations for role distribution for performing recognition, autonomous driving, and integrated mission such as detection of information, communication with the control server 10 and preprocessing of received information. The expansion mode can be a mode in which both the driving force of the driving mobility 20a and the driving force of the driven mobility 20b are used.

Examples related to the role distribution and integrated mission performance are described. However, it can be understood that the role distribution and integrated mission performance are not limited to the examples below.

For example, in the traction mode, the processor 22 of the driving mobility 20a can process a calculation for control and control the operation of the driving mobility 20a according to the calculation, and the components of the driven mobility 20b can be not operated or can be in a sleep mode. In the distributed mode, the processor 22 of the driving mobility 20a and the processor 22 of the driven mobility 20b can distribute and process the calculation for the control and control the operations of the driving mobility 20a and the driven mobility 20b according to the calculation. For example, in the distributed mode, the driving mobility 20a may be responsible for the autonomous driving and the integrated mission performance, and the driven mobility 20b may be responsible for the detection and recognition of the information. In the expansion mode, the processor 22 of the driving mobility 20a and the processor 22 of the driven mobility 20b can perform the calculation for control and control the operation of the driving mobility 20a and the driven mobility 20b according to the calculation. For example, when a load weight to be transported to the destination increases, the processor 22 of the driving mobility 20a and/or the processor 22 of the driven mobility 20b may plan the route to the destination, calculate the speed and/or the torque of the driving mobility 20a and the speed and/or the torque of the driven mobility 20b when driving along the route, and control the operation of the driving mobility 20a and the driven mobility 20b so that the driving mobility 20a and the driven mobility 20b drive along the route with the speed and/or the torque.

The driving mobility 20a and the driven mobility 20b may be handled as a virtual integrated mobilities to perform the integrated mission. FIGS. 5A to 5D illustrate examples of the virtual integrated mobility.

FIG. 5A illustrates the integrated mobility in which the driving mobility 20a and the driven mobility 20b are connected in a row, and the driving mobility 20a and the driven mobility 20b are connected so that the driving mobility 20a and the driven mobility 20b cannot rotate relative to each other by the mechanical coupling 30. Here, the driving mobility 20a and the driven mobility 20b can behave as one rigid body and can have a generally rectangular virtual integrated shape 40. Therefore, when performing the operation for controlling the driving mobility 20a and the driven mobility 20b, the driving mobility 20a and the driven mobility 20b may be handled as the one rigid body having the virtual integrated shape 40.

FIG. 5B illustrates the integrated mobility in which the driving mobility 20a and two driven mobilities 20b are connected in a row, and the driving mobility 20a and the two driven mobilities 20b are connected so that the driving mobility 20a and the two driven mobilities 20b cannot rotate relative to each other by the mechanical coupling 30. Here, the driving mobility 20a and the two driven mobilities 20b can behave as the one rigid body. Therefore, when performing the operation for controlling the driving mobility 20a and the driven mobility 20b, the driving mobility 20a and the driven mobility 20b may be handled as the one rigid body having the virtual integrated shape 40.

FIGS. 5C and 5D illustrate integrated mobilities in which the driving mobility 20a and the driven mobility are connected in a row, and the driving mobility 20a and the driven mobility 20b are connected so that the driving mobility 20a and the driven mobility 20b can rotate or swing relative to each other by the mechanical coupling 30. Here, the driving mobility 20a and the driven mobility 20b can behave as the one rigid body and have the virtual integrated shape 40. Therefore, when performing the operation for controlling the driving mobility 20a and the driven mobility 20b, the driving mobility 20a and the driven mobility 20b may be handled as the one rigid body having the virtual integrated shape 40.

For example, in FIG. 5C, the virtual integrated shape 40 may be handled as having a rectangular shape in which an entire length of the driving mobility 20a and the driven mobility 20b connected to each other by the mechanical coupling 30 and an entire width of the rotatable driven mobility 20b are two sides. The virtual integrated shape 40 illustrated in FIG. 5C can improve the stability of control, but the constraint area may increase unnecessarily when calculating the route or the movement of the integrated mobility.

On the contrary, in FIG. 5D, the virtual integrated shape 40 may be handled as having a possible shape that combines the driving mobility 20a and the driven mobility 20b rotating with respect to the driving mobility 20a. The virtual integrated shape 40 illustrated in FIG. 5D slightly reduces the stability of control, but may prevent the unnecessary increase in the constraint area when calculating the route or the movement of the integrated mobility. In addition, the amount of calculation may increase, and when the integrated mobility moves only in a straight line, the virtual integrated shape 40 still includes the unnecessary constraint areas.

The virtual integrated shape 40 can be used in a special case where the integrated mobility rotates only in one direction. In such case, the virtual integrated shape 40 may have an arc shape with the center of rotation of the integrated mobility as the center of the circle. The virtual integrated shape 40 may prevent the constraint areas from being excessively set without damaging the stability of control in the special case where the integrated mobility rotates only in one direction.

Referring back to FIG. 4, while the integrated mobility is performing the integrated mission, the control server 10 and/or the processor 22 of the driving mobility 20a can determine whether the disconnection condition is satisfied in operation S170. For example, when the integrated mobility completes the integrated mission, it can be determined that the disconnection condition is satisfied.

When it is determined that the disconnection condition is satisfied in the step S170, the control server 10 can transmit the disconnection command to the processor 22 of the driving mobility 20a and/or the processor 22 of the driven mobility 20b, and/or the processor 22 of the driving mobility 20a can transmit the disconnection command to the processor 22 of the driven mobility 20b.

The driving mobility 20a and the driven mobility 20b that have received the disconnection command can perform the mechanical disconnection process in operation S180. For example, the mechanical coupling 30 can separate the driving mobility 20a and the driven mobility 20b under the control of the control server 10 and/or the processor 22 of the driving mobility 20a.

When the connection condition is not satisfied in the operation S110 or the disconnection condition is not satisfied in the operation S170, the driving mobility 20a and the driven mobility 20b can continue to perform the corresponding mission (the individual mission or the integrated mission).

While example embodiments has been described in present disclosure, it can be understood that embodiments of the present disclosure are not necessarily limited to the disclosed embodiments. On the contrary, the present disclosure is intended to cover various modifications and equivalent arrangements included within the spirit and scopes of the appended claims.

What is claimed is:

1. A system for controlling a plurality of mobilities, wherein the plurality of mobilities include a driving mobility and a driven mobility, the system comprising:
one or more processors; and
a storage medium storing computer-readable instructions that, when executed by the one or more processors, enable the one or more processors to:
receive data confirming a state of the driving mobility and the driven mobility,
determine whether a connection condition is satisfied based on the data,
transmit a connection command to the driving mobility and the driven mobility in response to the connection condition being satisfied,
control the driving mobility and the driven mobility to be mechanically connected by a mechanical coupling in response to receiving the connection command, and
control the driving mobility and the driven mobility to perform an integrated mission in response to completion of the mechanical connection of the driving mobility and the driven mobility.

2. The system of claim 1, wherein the instructions further enable the one or more processors to:
select an operation mode from an operation mode set; and
distribute roles to the driving mobility and the driven mobility according to the selected operation mode so that the distributed roles can be performed by the driving mobility and the driven mobility.

3. The system of claim 2, wherein the operation mode set includes:
a traction mode configured to operate only with a first driving force of the driving mobility;
a distributed mode configured such that the driving mobility and the driven mobility distribute and process a distributed mode calculation and an operation for performing the integrated mission; and
an expansion mode configured such that both the first driving force of the driving mobility and a second driving force of the driven mobility are used.

4. The system of claim 3, wherein the instructions further enable the one or more processors to, in the traction mode, configure the driving mobility to process a traction mode calculation for controlling the integrated mission and configure the driving mobility to control the operation of the driving mobility according to the traction mode calculation.

5. The system of claim 3, wherein the instructions further enable the one or more processors to, in the distributed mode, configure the driving mobility and the driven mobility to process the distributed mode calculation for controlling the integrated mission and configure the driving mobility and the driven mobility to control the operation of the driving mobility and the driven mobility according to the distributed mode calculation.

6. The system of claim 3, wherein the instructions further enable the one or more processors to, in the expansion mode, configure the driving mobility to process an expansion mode calculation for controlling the integrated mission and configure the driving mobility to control the operation of the driving mobility and the driven mobility according to the expansion mode calculation.

7. The system of claim 1, wherein instructions further enable the one or more processors to configure a control server, the driving mobility, or the driven mobility to control the driving mobility and the driven mobility to be separated from each other in response to completion of the performance of the integrated mission.

8. The system of claim 1, wherein instructions further enable the one or more processors to configure a control server to transmit the state of the driven mobility or the driving mobility to the driving mobility or the driven mobility.

9. The system of claim 8, wherein the driving mobility or the driven mobility includes a user interface, and wherein the instructions further enable the one or more processors to provide the state of the driving mobility or the driven mobility to be displayed through the user interface.

10. The system of claim 9, wherein the instructions further enable the one or more processors to configure the driving mobility or the driven mobility to receive a driver's input through the user interface and transmit the received driver's input to the control server.

11. The system of claim 1, further comprising a control server configured to be communicatively connected to the driving mobility and the driven mobility, wherein the one or more processors are located in the control server.

12. The system of claim 1, further comprising a control server configured to be communicatively connected to the driving mobility and the driven mobility;
wherein the control server is configured to receive the data confirming the state of the driving mobility and the driven mobility, determine whether the connection condition is satisfied based on the data, and transmit a connection command; and
wherein the driving mobility or the driven mobility is configured to control the driving mobility and the driven mobility to be mechanically connected and to control the driving mobility and the driven mobility to perform the integrated mission.

13. A method for controlling a plurality of mobilities, wherein the plurality of mobilities include a driving mobility and a driven mobility, and wherein the driving mobility and the driven mobility can be communicatively connected to each other and communicatively connected to a control server, the method comprising:
determining, by the control server, whether a connection condition is satisfied;
controlling, by the control server or the driving mobility, a mechanical connection of the driving mobility and the driven mobility in response to the connection condition being satisfied; and
controlling, by the control server or the driving mobility, the driving mobility and the driven mobility to perform an integrated mission in response to completion of the mechanical connection of the driving mobility and the driven mobility.

14. The method of claim 13, wherein the controlling of the driving mobility and the driven mobility to perform the integrated mission comprises:
selecting an operation mode from an operation mode set;
distributing a role to the driving mobility and the driven mobility according to the operation mode; and
performing the distributed role by the driving mobility and the driven mobility.

15. The method of claim 14, wherein the operation mode set comprises:
a traction mode configured to operate only with a first driving force of the driving mobility;
a distributed mode configured such that the driving mobility and the driven mobility distribute and process a distributed mode calculation and an operation for performing the integrated mission; and
an expansion mode configured so that both the first driving force of the driving mobility and a second driving force of the driven mobility are used.

16. The method of claim 15, wherein, in the traction mode, the driving mobility is configured to process a traction mode calculation for controlling the integrated mission and control the operation of the driving mobility according to the traction mode calculation.

17. The method of claim 15, wherein, in the distributed mode, the driving mobility and the driven mobility are configured to process the distributed mode calculation for controlling the integrated mission and control the operation of the driving mobility and the driven mobility according to the distributed mode calculation.

18. The method of claim 15, wherein, in the expansion mode, a processor of the driving mobility is configured to process an expansion mode calculation for controlling the integrated mission and control the operation of the driving mobility and the driven mobility according to the expansion mode calculation.

19. The method of claim 13, further comprising controlling the driving mobility and the driven mobility so that the driving mobility and the driven mobility are separated from each other in response to completion of the performance of the integrated mission by the control server, the driving mobility, or the driven mobility.

20. A method for controlling a plurality of mobilities, wherein the plurality of mobilities include a driving mobility and a driven mobility, the method comprising:
determining whether a connection condition is satisfied;
controlling a mechanical connection of the driving mobility and the driven mobility in response to the connection condition being satisfied; and
controlling the driving mobility and the driven mobility to perform an integrated mission in response to completion of the mechanical connection of the driving mobility and the driven mobility, wherein the controlling of the driving mobility and the driven mobility to perform the integrated mission includes:
selecting an operation mode from an operation mode set, wherein the operation mode set includes:
a traction mode configured to operate only with a first driving force of the driving mobility,
a distributed mode configured such that the driving mobility and the driven mobility distribute and process a distributed mode calculation and an operation for performing the integrated mission, and
an expansion mode configured so that both the first driving force of the driving mobility and a second driving force of the driven mobility are used,
distributing roles to the driving mobility and the driven mobility according to the selected operation mode, and
performing the distributed roles by the driving mobility and the driven mobility.
